(19) United States
(12) Patent Application Publication
(10) Pub. No.: US 2026/0072444 A1
(43) Pub. Date: Mar. 12, 2026

(54) METHOD AND A SYSTEM FOR OPERATION OF AUTONOMOUS MOBILE VEHICLES IN AN OPERATING ENVIRONMENT

(71) Applicant: Rapyuta Robotics Co., Ltd., Tokyo (JP)

(72) Inventor: Abhishek SHARMA, Tokyo (JP)

(21) Appl. No.: 18/829,404

(22) Filed: Sep. 10, 2024

(51) Int. Cl. G05D 1/644; G05D 1/667; G05D 1/698; G05D 105/28; G05D 107/70

(52) U.S. Cl. CPC G05D 1/644; G05D 1/667; G05D 1/6987; G05D 2105/285; G05D 2107/70

(57) ABSTRACT

The present disclosure relates to a method and computing system 106 for operation of autonomous mobile vehicles in an operating environment. The method comprises receiving information related to a plurality of aisles in an operating environment. Further, the method comprises classifying the plurality of aisles as one or more active aisles and one or more inactive aisles. The one or more active aisles are associated with at least one pending task of a plurality of autonomous mobile vehicles 102. Thereafter, the method comprises determining a task from a set of tasks to be performed by at least one autonomous mobile vehicle from the plurality of autonomous mobile vehicles 102 by associating a position of the corresponding autonomous mobile vehicle with one of, the one or more active aisles or the one or more inactive aisles, based on one or more pre-defined constraints and a pre-defined cost function.

### TECHNICAL FIELD

The present disclosure generally relates to the field of autonomous mobile vehicles. More particularly, the present disclosure relates to a method and a system for operation of autonomous mobile vehicles in an operating environment.

### BACKGROUND

Autonomous mobile vehicles are used in a wide range of applications to perform multiple tasks. For example, the autonomous mobile vehicles are deployed as guided vehicles, automated storage and retrieval systems, robotic arms, and the like, in an operating environment. The autonomous mobile vehicles navigate and move around spaces in the operating environment independently when performing the tasks.

Order picking, which involves retrieving items from storage units is a core function in the operation environment (for example, warehouses). There are existing systems available that collaborate humans and autonomous mobile vehicles, to achieve efficient order picking. In such systems, the humans (also referred as pickers) perform item retrieval task i.e., picking the items from the storage units and placing them on the autonomous mobile vehicles. The autonomous mobile vehicles perform tasks such as transporting these items to a drop location. Such systems leverage the strengths of both the humans and the autonomous mobile vehicles to achieve faster order fulfilment.

Conventional systems that aim to improve productivity in the operating environment focus on minimizing travel distance of the autonomous mobile vehicles. For instance, some conventional systems disclose placing one or more totes on the autonomous mobile vehicles to pick the items and drop in the one or more totes, to minimize the travel distance of the autonomous mobile vehicles. Also, the conventional systems disclose solutions to enable an autonomous mobile vehicle to arrive at a pick location in quickest time, considering intentions and paths of other autonomous mobile vehicles. As the autonomous mobile vehicle needs to collaborate with the pickers in the operating environment to achieve efficient order picking, it is essential to enhance productivity in terms of both the pickers and the autonomous mobile vehicles. However, the conventional systems focus only on the travel distance of the autonomous mobile vehicles. There are no solutions available to improve the productivity in the operating environment with respect to walking time of the pickers.

The information disclosed in this background of the disclosure section is only for enhancement of understanding of the general background of the invention and should not be taken as an acknowledgement or any form of suggestion that this information forms the prior art already known to a person skilled in the art.

### SUMMARY

In an embodiment, the present disclosure discloses a method of operation of autonomous mobile vehicles in an operating environment. The method comprises receiving information related to a plurality of aisles in an operating environment. Further, the method comprises classifying the plurality of aisles as one or more active aisles and one or more inactive aisles, based on the received information. The one or more active aisles are associated with at least one pending task of a plurality of autonomous mobile vehicles. Thereafter, the method comprises determining a task from a set of tasks to be performed by at least one autonomous mobile vehicle from the plurality of autonomous mobile vehicles by associating a position of the corresponding autonomous mobile vehicle with one of, the one or more active aisles or the one or more inactive aisles. The association is performed based on one or more pre-defined constraints and a pre-defined cost function.

In an embodiment, the present disclosure discloses a computing system for operation of autonomous mobile vehicles in an operating environment. The computing system comprises one or more processors and a memory. The one or more processors are configured to receive information related to a plurality of aisles in an operating environment. Further, the one or more processors are configured to classify the plurality of aisles as one or more active aisles and one or more inactive aisles, based on the received information. The one or more active aisles are associated with at least one pending task of a plurality of autonomous mobile vehicles. Thereafter, the one or more processors are configured to determine a task from a set of tasks to be performed by at least one autonomous mobile vehicle from the plurality of autonomous mobile vehicles by associating a position of the corresponding autonomous mobile vehicle with one of, the one or more active aisles or the one or more inactive aisles. The association is performed based on one or more pre-defined constraints and a pre-defined cost function.

In an embodiment, the present disclosure discloses a non-transitory computer readable medium including instructions stored thereon that when processed by one or more processors cause a computing system to operate autonomous mobile vehicles in an operating environment. The one or more processors are configured to receive information related to a plurality of aisles in an operating environment. Further, the one or more processors are configured to classify the plurality of aisles as one or more active aisles and one or more inactive aisles, based on the received information. The one or more active aisles are associated with at least one pending task of a plurality of autonomous mobile vehicles. Thereafter, the one or more processors are configured to determine a task from a set of tasks to be performed by at least one autonomous mobile vehicle from the plurality of autonomous mobile vehicles by associating a position of the corresponding autonomous mobile vehicle with one of, the one or more active aisles or the one or more inactive aisles. The association is performed based on one or more pre-defined constraints and a pre-defined cost function.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The novel features and characteristics of the disclosure are set forth in the appended claims. The disclosure itself, however, as well as a preferred mode of use, further objectives, and advantages thereof, will best be understood by reference to the following detailed description of an illustrative embodiment when read in conjunction with the accompanying figures. One or more embodiments are now described, by way of example only, with reference to the accompanying figures wherein like reference numerals represent like elements and in which:

FIG. 1 illustrates an exemplary environment of operation of autonomous mobile vehicles in an operating environment, in accordance with some embodiments of the present disclosure;

FIG. 2 illustrates a detailed diagram of a computing system, in accordance with some embodiments of the present disclosure;

FIG. 3 shows an exemplary illustration for classifying a plurality of aisles in the operating environment, in accordance with some embodiments of the present disclosure;

FIGS. 4A-4E and 6A-6D show exemplary illustrations for associating a position of autonomous mobile vehicle with the plurality of aisles, in accordance with some embodiments of the present disclosure;

FIGS. 5A-5E show exemplary flow diagrams for operation of the autonomous mobile vehicles in the operating environment, in accordance with some embodiments of the present disclosure;

FIG. 7 shows an exemplary flow chart illustrating method steps for operation of the autonomous mobile vehicles in the operating environment, in accordance with some embodiments of the present disclosure; and

FIG. 8 shows a block diagram of a general-purpose computing system for operation of the autonomous mobile vehicles in the operating environment in accordance with embodiments of the present disclosure.

It should be appreciated by those skilled in the art that any block diagram herein represents conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternatives falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or apparatus.

Order picking, which involves retrieving items from storage units is a core function in the operation environment. There are existing systems available that collaborates humans and autonomous mobile vehicles, to achieve efficient order picking. Conventional systems that aim to improve productivity in the operating environment focus on minimizing travel distance of the autonomous mobile vehicles. As the autonomous mobile vehicle needs to collaborate with the pickers in the operating environment to achieve efficient order picking, it is essential to enhance productivity in terms of both the pickers and the autonomous mobile vehicles. However, the conventional systems focus only on the travel distance of the autonomous mobile vehicles. There are no solutions available to improve the productivity in the operating environment with respect to walking time of the pickers.

Accordingly, the present disclosure provides a method and a computing system for operation of autonomous mobile vehicles in an operating environment. The present disclosure utilizes aisles in the operating environment, for managing operation of the autonomous mobile vehicles. In the present disclosure, a position of an autonomous mobile vehicle to perform a task at a pick/drop location is associated with an aisle in the operating environment. Further, the present disclosure classifies active aisles and inactive aisles by identifying aisles associated with pending task of the autonomous mobile vehicles.

The present disclosure determines a task to be performed by an autonomous mobile vehicle from assigned set of tasks by associating a position of the autonomous mobile vehicle with the active aisle or the inactive aisle. This association is performed based on pre-defined constraints and a pre-defined cost function. For instance, the present disclosure determines tasks to be performed by the autonomous mobile vehicles for which the pick locations/drop locations are associated with the active aisles. In this way, the present disclosure enables picking or dropping by an autonomous mobile vehicle in proximity to the active aisles where other autonomous mobile vehicles are already operating. Also, the pick/drop locations of the autonomous mobile vehicles are associated with the inactive aisles only when required and based on a distance of the inactive aisles to all active aisles. In this way, the present disclosure considers various constraints while associating positions of the autonomous mobile vehicles to the aisles for performing the task. This improves productivity in performing the picking/dropping task by reducing the walking time of the pickers.

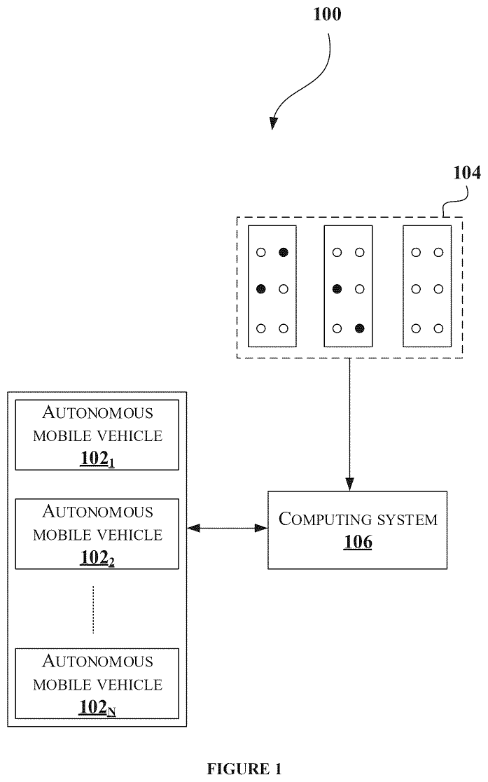

FIG. 1 illustrates an exemplary environment for operation of autonomous mobile vehicles in an operating environment, in accordance with some embodiments of the present disclosure. The exemplary environment 100 comprises an autonomous mobile vehicle 102₁, an autonomous mobile vehicle 102₂, . . . , and an autonomous mobile vehicle 102_{N} (collectively referred as a plurality of autonomous mobile vehicles 102 hereafter in the present description). The plurality of autonomous mobile vehicles 102 may include, but not limited to, a robot, a guided vehicle, a robotic arm, a forklift, and the like. The plurality of autonomous mobile vehicles 102 are configured to perform tasks in the operating environment. The tasks may include, for example, picking an item from a storage unit, dropping the item to a drop location, placing the item in the storage unit, and the like. The operating environment may include for example, a warehouse, a supermarket, a department store, a hypermarket, and the like.

Each of the plurality of autonomous mobile vehicles 102 perform a set of tasks in the operating environment. The tasks may be one of, a picking task or a dropping task. In an example, each task may be associated with one or more pick/drop locations. There are three workflows defined in the operating environment including a replenishment workflow, an induction workflow, and a picking workflow. The replenishment workflow defines a process of restocking or reordering the storage units. In the replenishment workflow, the plurality of autonomous mobile vehicles 102 are involved in placing/dropping the item in the storage unit. Hence, the dropping task is associated with the replenishment workflow in the operating environment. The induction workflow defines a process of loading the plurality of autonomous mobile vehicles 102 with items from the storage units. In the induction workflow, the plurality of autonomous mobile vehicles 102 are involved in picking the items from the storage units and placing in the plurality of autonomous mobile vehicles 102 (for example, in one or more totes placed on the plurality of autonomous mobile vehicles 102). The picking workflow defines a process of picking the items from the storage units for dropping to a drop location. Hence, the picking task is associated with one of, the picking workflow or the induction workflow.

The plurality of autonomous mobile vehicles 102 perform the respective set of tasks that are assigned. In an embodiment, a task assignment system is responsible for assigning the set of tasks to each of the plurality of autonomous mobile vehicles 102. In the present disclosure, a computing system 106 is configured to determine a task to be performed by each autonomous mobile vehicle, from the set of tasks assigned to corresponding autonomous mobile vehicle. In an embodiment, the computing system 106 is a part of the task assignment system. In another embodiment, the computing system 106 is outside the task assignment system and communicates with the task assignment system to receive the set of tasks. In an embodiment, the computing system 106 is a system implemented in the operating environment. In another embodiment, the computing system 106 is implemented in a remote location such as a cloud server. In yet another embodiment, the computing system 106 is implemented in each of the plurality of autonomous mobile vehicles 102. In such an embodiment, the computing system 106 of each autonomous mobile vehicle may communicate with computing systems 106 of other autonomous mobile vehicles.

In an embodiment, the computing system 106 is configured for operation of the plurality of autonomous mobile vehicles 102 in the operating environment. Herein, the computing system 106 receives information related to aisles in the operating environment from one or more sources. The one or more sources may include a database, a user, and the like. The information related to the aisles include associations between each aisle and pick locations/drop locations associated with the set of tasks of each of the plurality of autonomous mobile vehicles 102. The computing system 106 classifies the aisles into active aisles and inactive aisles, based on the received information. The active aisles are associated with a pending task of the plurality of autonomous mobile vehicles 102. For instance, referring to FIG. 1, the information related to the aisles is illustrated as 104. Three aisles are illustrated in 104. In FIG. 1, a filled circle represents a pending task (a pick or a drop task) of the plurality of autonomous mobile vehicles 102. As shown, a first aisle is associated with two pick/drop locations of the plurality of autonomous mobile vehicles 102. Hence, the first aisle is classified as an active aisle. A third aisle is not associated with any pending task of the plurality of autonomous mobile vehicles 102. Hence, the third aisle is classified as an inactive aisle.

In an embodiment, the computing system 106 determines a task from the set of tasks to be performed by at least one autonomous mobile vehicle from the plurality of autonomous mobile vehicles 102. In the present disclosure, the computing system 106 determines a task that an autonomous mobile vehicle needs to perform by associating a position of the corresponding autonomous mobile vehicle with the active aisles or the inactive aisles. The association is based on one or more pre-defined constraints and a pre-defined cost function. The one or more pre-defined constraints may comprise at least one of, minimizing a number of the active aisles, activating an inactive aisle as an active aisle based on a distance between the inactive aisle and each of the active aisles, maintaining a maximum limit indicating a ratio between a number of autonomous mobile vehicles and a number of the active aisles, and the like. A penalty value is assigned when a ratio between the number of autonomous mobile vehicles and the number of the active aisles exceeds the maximum limit. The pre-defined cost function may comprise at least one of, determining a distance from at least one inactive aisle among the inactive aisles to each of the one or more active aisles and assigning a penalty value while activating the at least one inactive aisle.

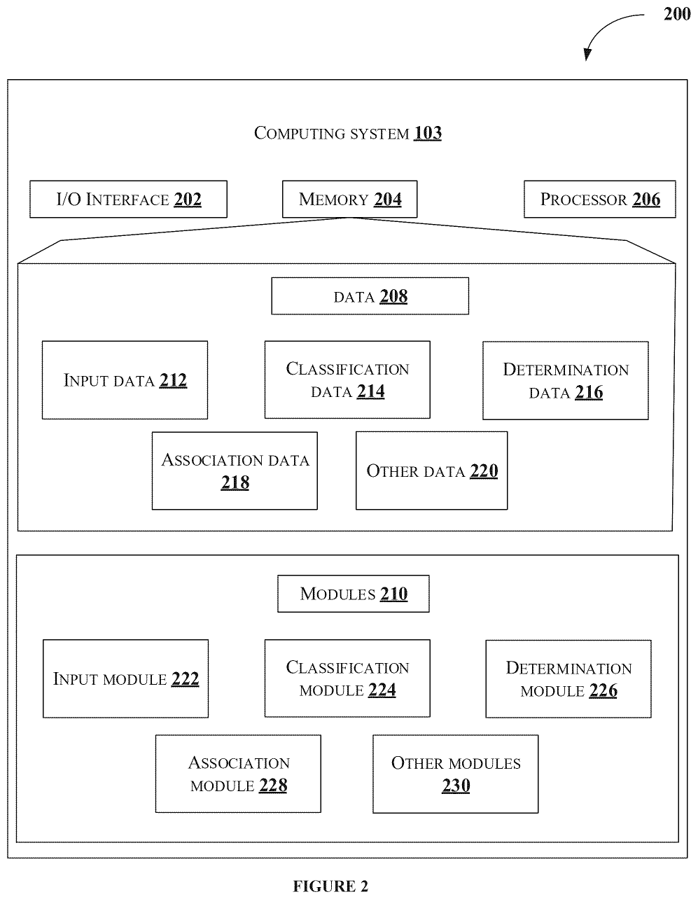

FIG. 2 illustrates a detailed diagram 200 of the computing system 106 for operation of the plurality of autonomous mobile vehicles 102 in the operating environment, in accordance with some embodiments of the present disclosure. The computing system 106 may include an I/O interface 202, a memory 204, and Central Processing Units 206 (also referred as “CPUs” or “one or more processors 206”). In some embodiments, the memory 204 may be communicatively coupled to the one or more processors 206. The memory 204 stores instructions executable by the one or more processors 206. The one or more processors 206 may comprise at least one data processor for executing program components for executing user or system-generated requests. The memory 204 may be communicatively coupled to the one or more processors 206. The memory 204 stores instructions, executable by the one or more processors 206, which, on execution, may cause the one or more processors 206 to determine a task for operation of the plurality of autonomous mobile vehicles 102 in the operating environment. The I/O interface 202 is coupled with the one or more processors 206 through which an input signal or/and an output signal is communicated. For example, the one or more processors 206 may communicate with the plurality of autonomous mobile vehicles 102 via the I/O interface 202.

In an embodiment, the memory 204 may include one or more modules 210 and data 208. The one or more modules 210 may be configured to perform the steps of the present disclosure using the data 208, to determine a task for operation of the plurality of autonomous mobile vehicles 102 in the operating environment. In an embodiment, each of the one or more modules 210 may be a hardware unit which may be outside the memory 204 and coupled with the computing system 106. As used herein, the term modules 210 refers to an Application Specific Integrated Circuit (ASIC), an electronic circuit, a Field-Programmable Gate Arrays (FPGA), Programmable System-on-Chip (PSoC), a combinational logic circuit, and/or other suitable components that provide described functionality. The one or more modules 210 when configured with the described functionality defined in the present disclosure will result in a novel hardware.

In one implementation, the modules 210 may include, for example, an input module 222, a classification module 224, a determination module 226, an association module 228 228, and other modules 230. It will be appreciated that such aforementioned modules 210 may be represented as a single module or a combination of different modules. In one implementation, the data 208 may include, for example, input data 212, classification data 214, determination data 216, association data 218, and other data 220.

In an embodiment, the input module 222 may be configured to receive information related to the plurality of aisles in the operating environment. The information related to the plurality of aisles include associations between one of, a pick location or a drop location associated with the set of tasks of each of the plurality of autonomous mobile vehicles 102 and each of the plurality of aisles. In an embodiment, the input module 222 may receive information related to the plurality of aisles from a database. The associations between the pick location or the drop location associated with the set of tasks of each of the plurality of autonomous mobile vehicles 102 and each of the plurality of aisles may be stored in the database. In an embodiment, the input module 222 may receive the associations from an association module 228. For instance, the association module 228 may be part of the other modules 230. The information related to the plurality of aisles may be stored as the input data 212 in the memory 204.

The functions of the association module 228 are explained below in detail.

The association module 228 may associate the pick location/the drop location associated with the set of tasks of each of the plurality of autonomous mobile vehicles 102 and each of the plurality of aisles. Herein, the association module 228 may identify the plurality of aisles in the operating environment. In an embodiment, the plurality of aisles or aisle regions may be auto generated based on a map of the operating environment. For instance, object recognition may be used to identify the plurality of aisles. A person skilled in the art will appreciate that any other method may be used to identify the plurality of aisles. Then, the association module 228 may identify the pick locations or drop locations associated with each task of the set of tasks of the plurality of autonomous mobile vehicles 102. For example, an autonomous mobile vehicle 1 may be associated with a task 1 at a pick location 1 and a pick location 3. An autonomous mobile vehicle 2 may be associated with a task 2 at a pick location 2 and a drop location 5. These pick locations or drop locations associated with each task of the set of tasks of the plurality of autonomous mobile vehicles 102 may be identified.

Then, the association module 228 may associate the pick location/the drop location associated with the set of tasks of each of the plurality of autonomous mobile vehicles 102 with each of the plurality of aisles. In an embodiment, the association module 228 may associate the pick location or the drop location of each of the plurality of autonomous mobile vehicles 102 with nearest aisle from the plurality of aisles. The nearest aisle may be identified based on a distance from the pick location or the drop location to each of the plurality of aisles. For example, consider that the pick location 1 of the autonomous mobile vehicle may be nearest to aisle 2. In such case, the pick location 1 is associated with the aisle 2. In an embodiment, a Euclidean distance from the pick location or the drop location to each of the plurality of aisles may be determined to identify the nearest aisle. A person skilled in the art will appreciate that any other technique may be used to calculate a distance for identifying the nearest aisle. In an embodiment, the association module 228 may perform the associations or update the associations when a new task is assigned to an autonomous mobile vehicle. In another embodiment, the association module 228 may perform the associations or update the associations when there is an update on aisle regions. In yet another embodiment, the association module 228 may perform the associations or update the associations when there is an update on the pick locations or the drop locations.

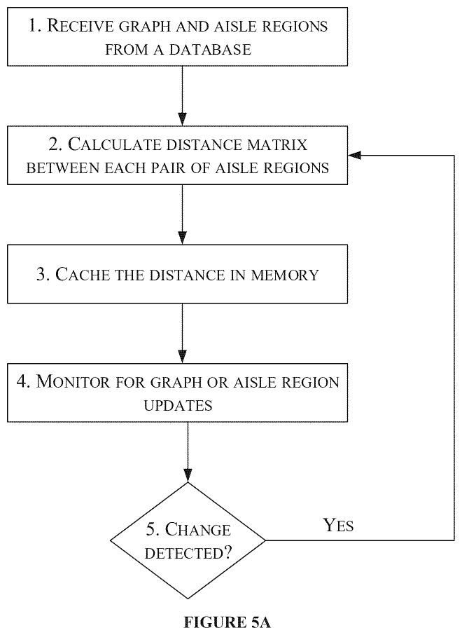

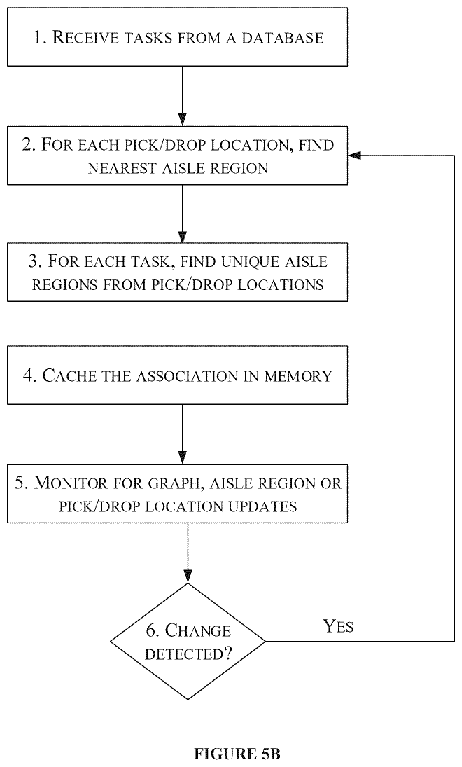

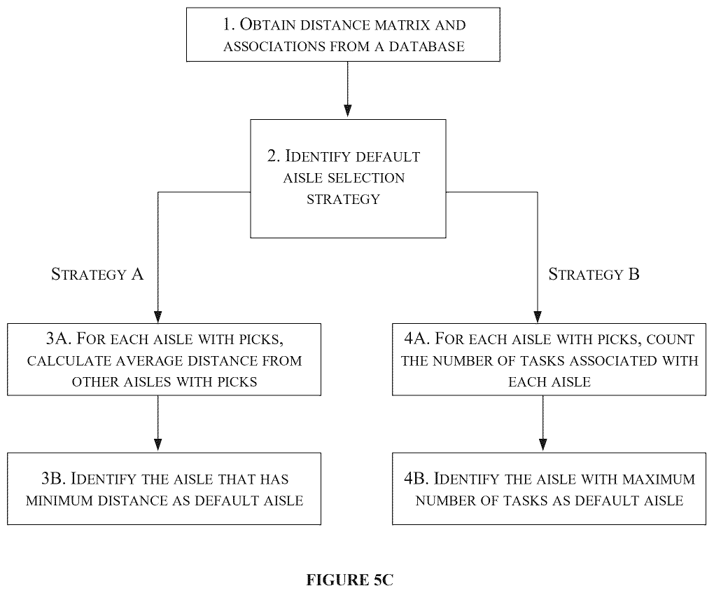

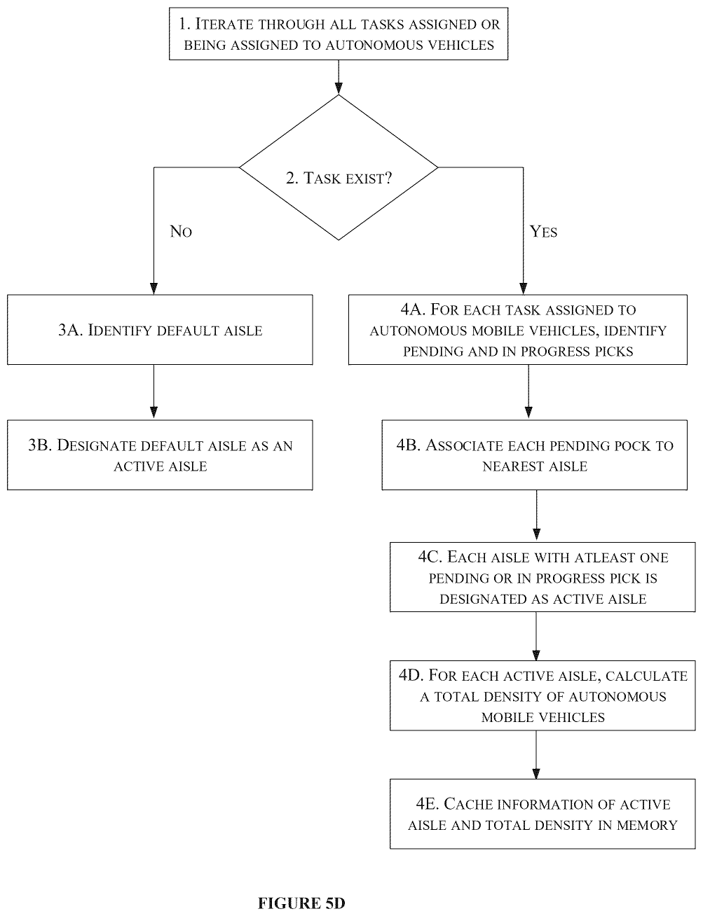

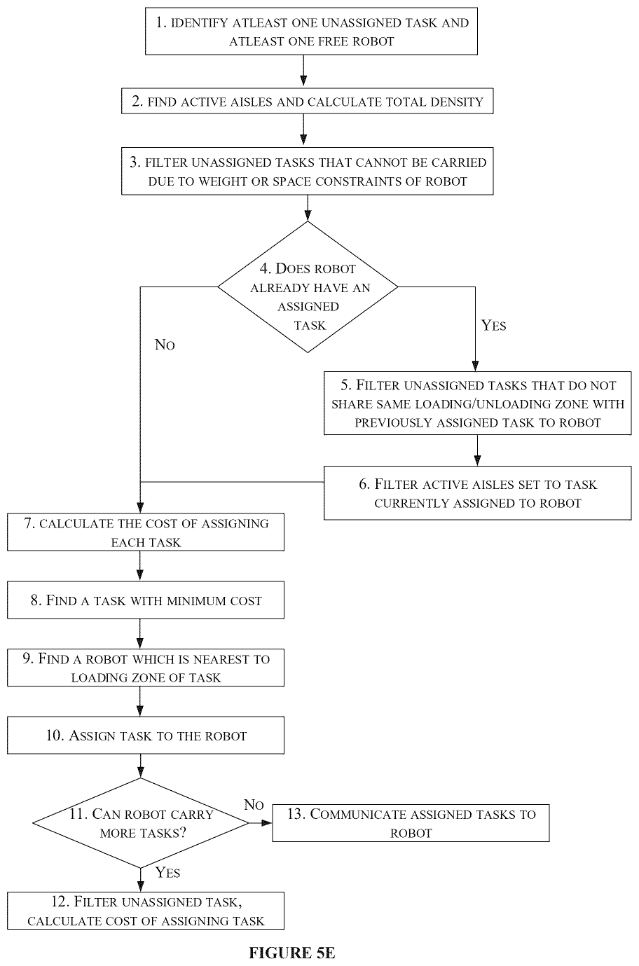

Reference is made to FIG. 5B illustrating exemplary flow diagram for associating the pick location/the drop location associated with the set of tasks of each of the plurality of autonomous mobile vehicles 102 with each of the plurality of aisles. At step 1, the association module 228 may receive the set of tasks of each of the plurality of autonomous mobile vehicles from the database. The association module 228 may identify nearest aisle region for each pick/drop location, as shown in step 2. The association module 228 may associate the pick locations or the drop locations of each task of the plurality of autonomous mobile vehicles 102 to identify a list of unique aisle regions, as shown in step 3. The association module 228 may store the list of unique aisles and the associations in a memory or the database, as shown in step 4. The association module 228 may monitor whether there is any update in the graph, the aisle regions, or the pick/drop locations, as shown in step 5. The association module 228 may update the associations, upon detecting the update in the graph, the aisle regions, or the pick/drop locations, as shown in step 6. Referring back to FIG. 2, the associations of the pick location/the drop location and each of the plurality of aisles may be stored as the association data 218 in the memory 204.

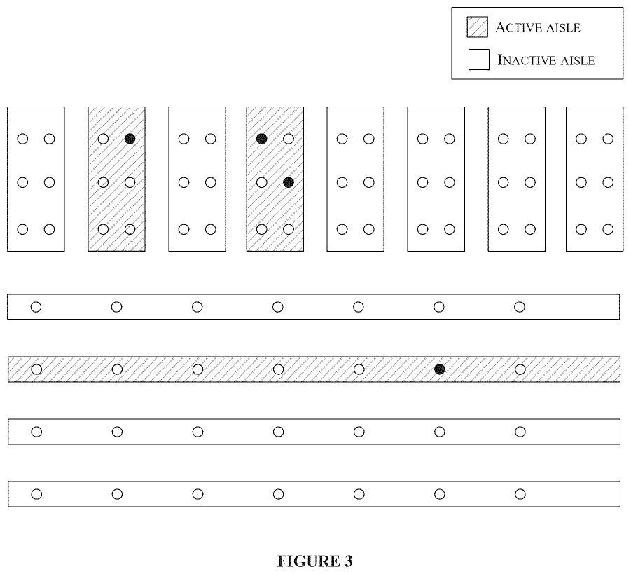

In an embodiment, the classification module 224 may be configured to receive the input data 212 from the input module 222. Further, the classification module 224 may be configured to classify the plurality of aisles as one or more active aisles and one or more inactive aisles, based on the received information. The one or more active aisles are associated with at least one pending task of a plurality of autonomous mobile vehicles 102. The at least one pending task of an autonomous mobile vehicle includes a task that is assigned to the autonomous mobile vehicle which is not initiated. Also, the at least one pending task of an autonomous mobile vehicle includes a task that is assigned to the autonomous mobile vehicle and initiated but is not completed. The one or more inactive aisles comprise aisles other than the one or more active aisles in the plurality of aisles. Referring to FIG. 3, the plurality of aisles in the operating environment are illustrated. A warehouse is considered as the operating environment. The pick locations/drop locations of the plurality of autonomous mobile vehicles 102 associated with the plurality of aisles are illustrated as filled circles. As shown, aisles associated with the pick locations/drop locations of pending tasks of the plurality of autonomous mobile vehicles 102 are classified as the one or more active aisles. Aisles other than the one or more active aisles i.e., the aisles which are not associated with any pending task of the plurality of autonomous mobile vehicles 102 are classified as the one or more inactive aisles.

In an example, consider that a pick location 4 of an autonomous mobile vehicle 1 is associated with aisle 3. The aisle 3 is classified as an active aisle. Consider that aisle 3 is not associated with any other pick/drop location of any other autonomous mobile vehicle. Picking an item from the pick location 4 may be considered as a pending task of the autonomous mobile vehicle 1. Once the pending task is completed by the autonomous mobile vehicle 1, the aisle 3 is not associated with any pick/drop location of any autonomous mobile vehicle. In such case, the aisle 3 is classified as an inactive aisle. Referring back to FIG. 2, a list of the one or more active aisles and the one or more inactive aisles may be stored as the classification data 214 in the memory 204.

In an embodiment, the determination module 226 may be configured to receive the classification data 214 from the classification module 224. Further, the determination module 226 may be configured to determine a task from the set of tasks to be performed by at least one autonomous mobile vehicle from the plurality of autonomous mobile vehicles 102. In the operating environment, each of the plurality of autonomous mobile vehicles 102 are associated with multiple tasks. The present disclosure enables determining a task to be performed by an autonomous mobile vehicle at a point in time, such that the productivity in the operating environment is improved. Herein, the determination module 226 associates a position of the corresponding autonomous mobile vehicle with one of, the one or more active aisles or the one or more inactive aisles, based on the one or more pre-defined constraints and the pre-defined cost function. Each of the plurality of autonomous mobile vehicles 102 needs to move to a position in the operating environment to complete a task, based on corresponding pick locations/drop locations. In the present disclosure, the position of the plurality of autonomous mobile vehicles 102 is associated to the plurality of aisles, to improve the productivity in the warehouse. Hence, the determination module 226 associates the position of the plurality of autonomous mobile vehicles 102 with the one or more active aisles or the one or more inactive aisles, based on the one or more pre-defined constraints and the pre-defined cost function. The function of the determination module 226 with respect to performing the associations based on the one or more pre-defined constraints and the pre-defined cost function is explained in detail below.

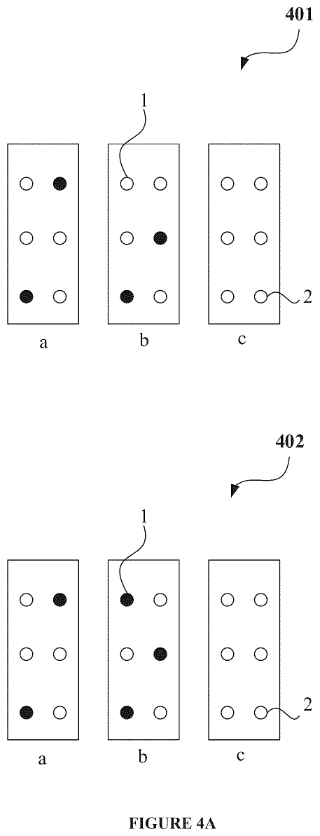

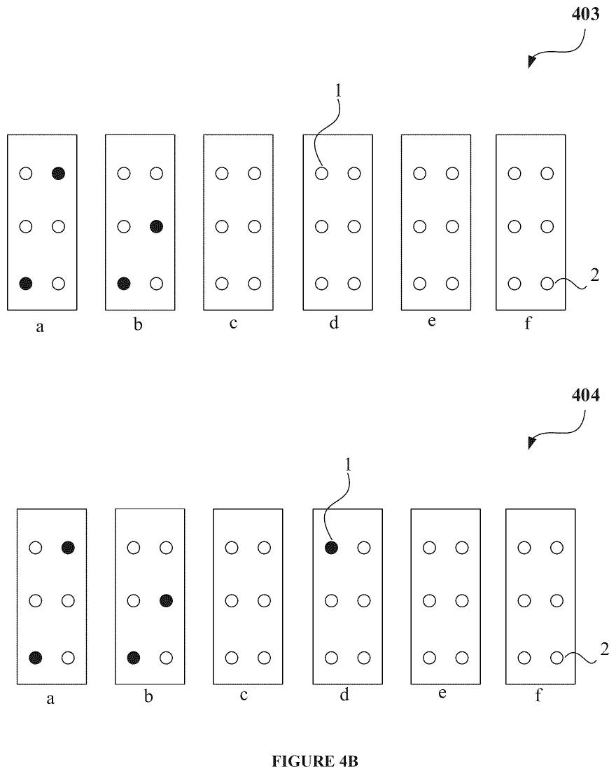

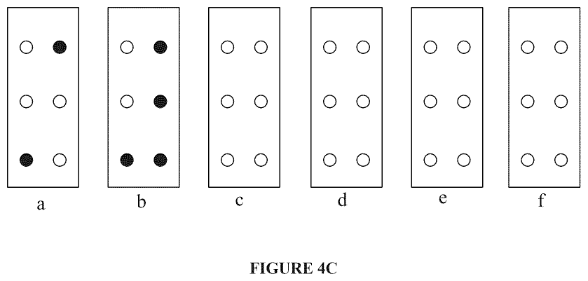

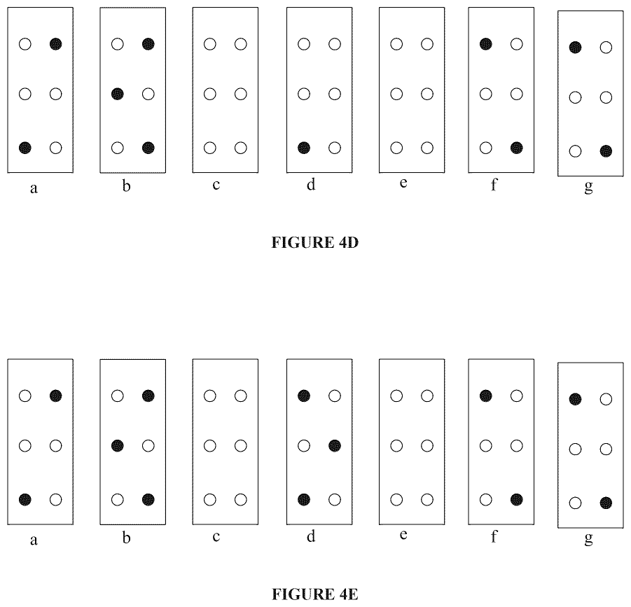

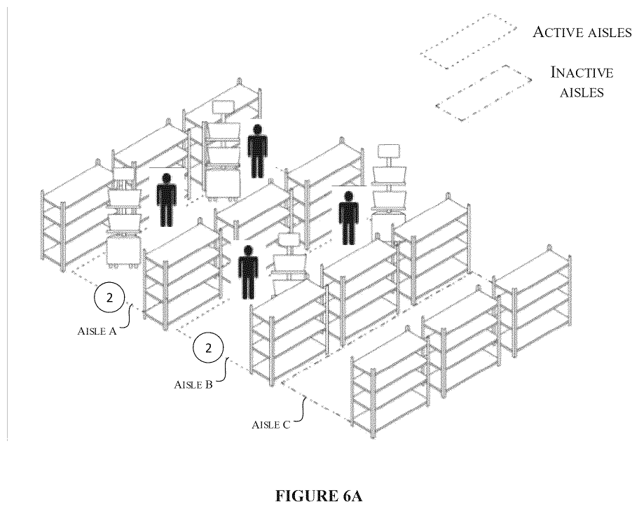

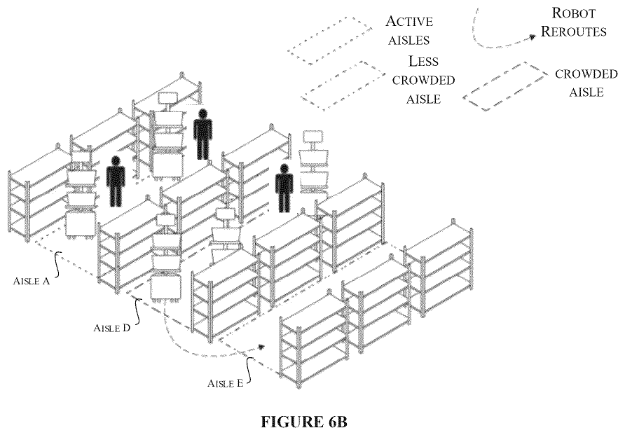

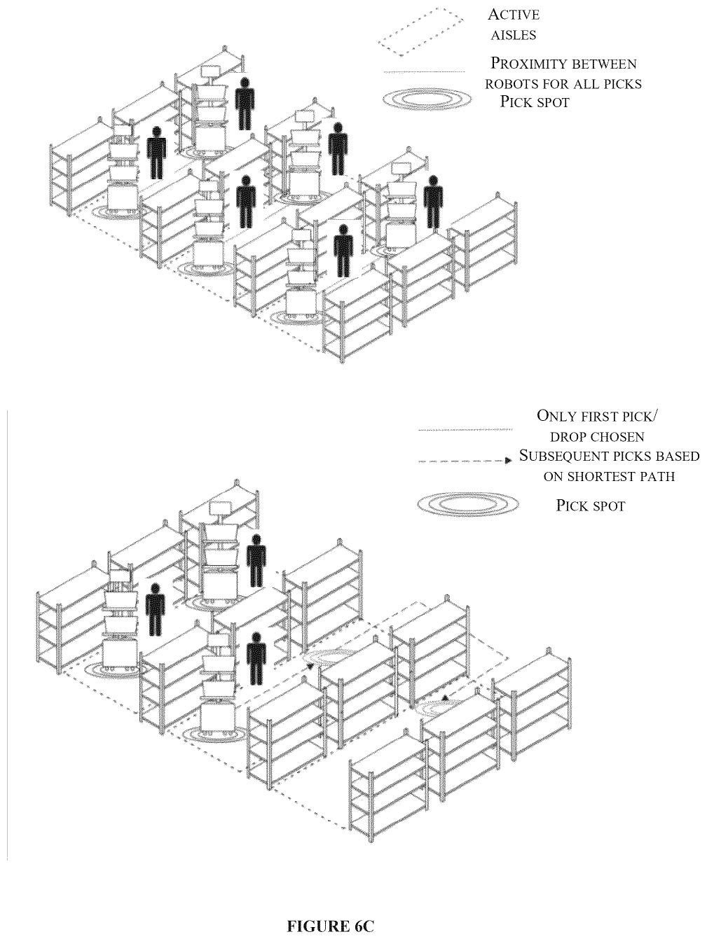

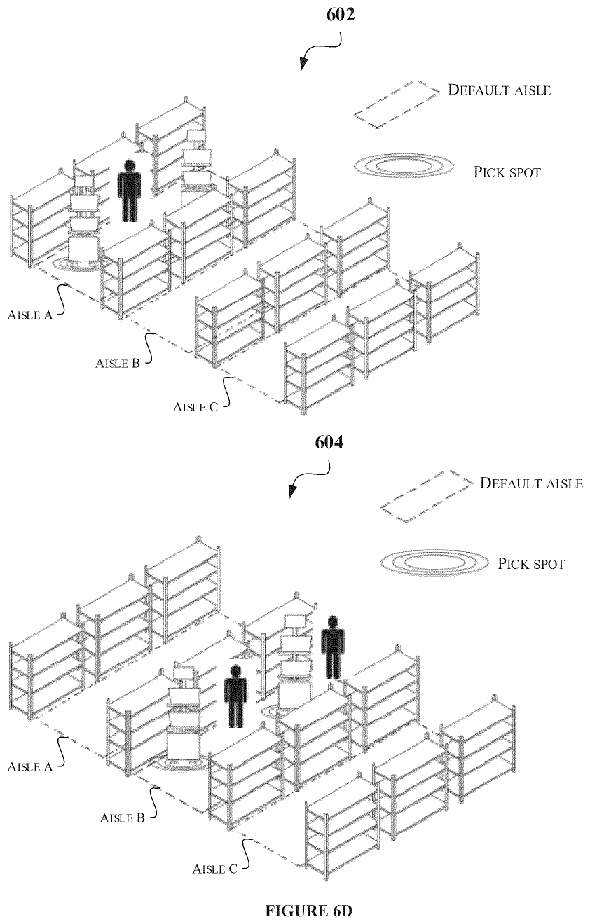

In an embodiment, the determination module 226 associates the position of the plurality of autonomous mobile vehicles 102 by minimizing a number of the one or more active aisles for each task of the set of tasks. The determination module 226 determines the task to be performed from the set of tasks based on the pick locations/drop locations of an autonomous mobile vehicle. Herein, the determination module 226 analyzes all the pick locations/drop locations of an autonomous mobile vehicle. The determination module 226 associates a pick location/drop location associated with a task from the set of tasks with an aisle where already other autonomous mobile vehicles are operating. The aisle where already other autonomous mobile vehicles are operating are the one or more active aisles in the present disclosure. In an example as illustrated in FIG. 6C, first/initial picks and drops of the plurality of autonomous mobile vehicles 102 are selected based on a proximity between the plurality of autonomous mobile vehicles 102 or nearby an aisle where other autonomous mobile vehicles are operating. Subsequent picks may be selected based on the shortest path. Hence, the determination module 226 provides higher weightage to the one or more active aisles than the one or more inactive aisles. The determination module 226 associates the position to the one or more active aisles, rather than activating an inactive aisle as an active aisle. Hence, the determination module 226 associates the position of the autonomous mobile vehicle by minimizing the number of active aisles. Referring to an example 401 illustrated in FIG. 4A, aisles a, b, and c are illustrated. The pick locations/drop locations associated with the plurality of aisles are illustrated as filled circles. Consider that a task 1 of the autonomous mobile vehicle is associated with a pick location 1 in proximity to aisle b. A task 2 of autonomous mobile vehicle is associated with a pick location 1 in proximity to aisle c. The determination module 226 determines the task 1 as a task to be performed by the autonomous mobile vehicle, as the pick location 1 is in proximity to the aisle b which is an active aisle. The task 2 is not considered to avoid activating aisle c from an inactive aisle to an active aisle. Hence, the position of the autonomous mobile vehicle is associated with the active aisle b as illustrated in 402 in FIG. 4A.

Referring back to FIG. 2, in an embodiment, the determination module 226 associates the position of the plurality of autonomous mobile vehicles 102 by activating at least one inactive aisle as an active aisle, based on a distance between the at least one inactive aisle and each of the one or more active aisles. As stated above, the determination module 226 avoids activating an inactive aisle as an active aisle. When there is a requirement to activate at least one inactive aisle, the determination module 226 determines a distance between the at least one inactive aisle and each of the one or more active aisles. The at least one inactive aisle that are activated are preferred to be in proximity of the one or more active aisles. In an embodiment, the determination module 226 determines the distance between the at least one inactive aisle and each of the one or more active aisles based on known techniques such as Euclidean distance. In another embodiment, the determination module 226 obtains distance between the plurality of aisles in the operating environment from a database. The distance between the plurality of aisles may be determined and pre-stored in the database as a distance matrix. To determine the distance, a coordinate of a centre of each of the plurality of aisles as {(x1+x2)/2, (y1+y2)/2} is considered to represent each aisle. A distance matrix comprising distance of each of the plurality of aisles with other aisles in form of a graph is generated. Any unidirectional edges in the graph may be replaced with bidirectional edges, since pickers/autonomous mobile vehicles can travel either way. A person skilled in the art will appreciate that any other methods may be used to determine the distance between the plurality of aisles. The pre-stored data may be updated when there is an update in aisle regions in the operating environment. Referring to an example 403 in FIG. 4B, aisles a-f are illustrated. Consider that a task 1 of the autonomous mobile vehicle is associated with a pick location 1 in proximity to aisle d. A task 2 of autonomous mobile vehicle is associated with a pick location 2 in proximity to aisle f. The distance between inactive aisle d to each of the active aisle's a and b is determined. Similarly, the distance between aisle f to each of the active aisle's a and b is determined. As the aisle d is closer to the aisles a and b, the aisle d may be activated as an active aisle as shown in 404 in FIG. 4.

Reference is made to FIG. 5A illustrating exemplary flow diagram for calculation of the distance matrix. As shown, the determination module 226 may obtain the graph and aisle regions from the database, at step 1. At step 2, the determination module 226 may calculate a distance matrix between each pair of aisle regions. In an embodiment, the determination module 226 may determine the distance matrix based on the above-stated equation. At step 3. The determination module 226 may store/cache the distance in a memory or the database. The determination module 226 may monitor whether there is any update in the graph or aisle region, as shown in step 4. The determination module 226 may update the distance matrix when the graph or aisle region is updated, as shown in step 5.

Referring back to FIG. 2, in an embodiment, the determination module 226 associates the position of the plurality of autonomous mobile vehicles 102 by maintaining a maximum limit indicating a ratio between a number of autonomous mobile vehicles and a number of the one or more active aisles. The determination module 226 may assign a penalty value when the ratio between the number of autonomous mobile vehicles and the number of the one or more active aisles exceeds the maximum limit. The maximum limit is maintained to avoid congestion in the operating environment. Referring to FIG. 4C, aisle b is associated with four pick/drop locations out of 6 locations in the aisle b. In such a case, the ratio between the number of autonomous mobile vehicles and the number of the one or more active aisles is 66.6%. Consider that the maximum limit is defined as 60%. As the ratio of 66.6% is exceeding the maximum limit, a penalty value may be assigned. Referring to FIG. 6A, a warehouse is illustrated with autonomous mobile vehicles and human pickers. Active aisles (aisle A and aisle B) and an inactive aisle (aisle C) in the warehouse are illustrated. As shown, each of the active aisles (aisles A and B) are associated with two autonomous mobile vehicles. In an example, the maximum limit may be defined as two. In such case, a penalty value is assigned when the ratio between the number of autonomous mobile vehicles and the number of the one or more active aisles exceeds two. In an example as illustrated in FIG. 6B, there are three autonomous mobile vehicles (for example, robots) in aisle D (referred as crowded aisle). A penalty value may be assigned in such a case considering that there are three autonomous mobile vehicles operating in one single aisle. The determination module 226 may determine that one autonomous mobile vehicle among the three autonomous mobile vehicles needs to be re-routed to another aisle, based on the penalty value. In such case, it may be determined that one of the autonomous mobile vehicles may re-route to a less crowded aisle (aisle E) among the plurality of aisles.

Referring back to FIG. 2, in an embodiment, the determination module 226 may associate the position of the at least one autonomous mobile vehicle with the one or more inactive aisles comprises activating the one or more inactive aisles as the one or more active aisles by minimizing the pre-defined cost function. The pre-defined cost function comprises at least one of determining a distance from at least one inactive aisle among the one or more inactive aisles to each of the one or more active aisles. Herein, an average distance between each inactive aisle to all the one or more active aisles is determined. Then, an average value is determined from average distances of the all the one or more inactive aisles. A penalty value is assigned while activating the at least one inactive aisle based on the average value.

In an embodiment, a reward is assigned when a position of the plurality of autonomous mobile vehicles 102 is associated with the one or more active aisles. Further, a reward is assigned when multiple pick locations/drop locations (for example, may be associated with a tote) of the plurality of autonomous mobile vehicles 102 is associated with a same aisle. A cost is determined for each of the set of tasks of an autonomous mobile vehicle by minimizing the cost function. A task associated with least cost is determined as a task to be performed by the autonomous mobile vehicle.

In an embodiment, the following steps are performed for identifying an active aisle when there are no active aisles in the operating environment. Herein, a list of unique aisles is identified by mapping the pick locations/drop locations of the autonomous mobile vehicle with the plurality of aisles. The list of unique aisles may be pre-stored in the database. Also, a current density of each of the plurality of autonomous mobile vehicles 102 may be stored in the database. The density of each of the plurality of autonomous mobile vehicles 102 may be determined using equation (1) stated below:

1.0/(Number of remaining active aisles associated with the autonomous mobile vehicle) (1)

For example, the density of an autonomous mobile vehicle with remaining picks from 3 aisles is 0.33. Further, characteristics of each of the plurality of autonomous mobile vehicles 102 may be stored in the database. The list of unique aisles may be obtained from the database to identify an active aisle from the plurality of aisles. An aisle associated with a maximum number of tasks of the plurality of autonomous mobile vehicles 102 is identified as the active aisle for associating the position of the at least one autonomous mobile vehicle. In an embodiment, the identification of the active aisle may be further based on characteristics of the plurality of autonomous mobile vehicles 102. The characteristics of the plurality of autonomous mobile vehicles 102 may include size, weight, volume, and the like. The characteristics of the plurality of autonomous mobile vehicles 102 may be considered to avoid congestion in the operating environment.

Referring to FIG. 4D, aisles a-g are illustrated. The aisle b is associated with three pick locations/drop locations of the plurality of autonomous mobile vehicles 102. Hence, the aisle b is identified as the active aisle. Referring back to FIG. 2, in an embodiment, one or more aisles of the plurality of aisles may be associated with a maximum number of tasks of the plurality of autonomous mobile vehicles 102. In such a case, a distance from the one or more aisles to other aisles of the plurality of aisles is determined. An aisle associated with a minimum distance to the other aisles is identified as the active aisle for associating the position of the at least one autonomous mobile vehicle. Referring to FIG. 4E, aisle b and d are associated with three pick locations/drop locations of the plurality of autonomous mobile vehicles 102. The aisle d is in centre and equidistant from other aisles. Hence, the aisle d is identified as the active aisle. Referring back to FIG. 2, the association of the position of the plurality of autonomous mobile vehicles 102 and the plurality of aisles may be stored as the determination data 216 in the memory 204.

Reference is made to FIG. 5C illustrating an exemplary flowchart for identifying a default aisle. Herein, the distance matrix and the associations of the pick/drop locations with each of the plurality of aisle may be obtained from the database, as shown in step 1. At step 2, a default aisle selection strategy may be identified. The default aisle selection strategy may be pre-configured for a particular operating environment. Hence, the default aisle selection strategy may be identified based on configuration in the operating environment. In an embodiment, a default aisle for associating position of the plurality of autonomous mobile vehicles 102 may be identified, based on a minimum distance (strategy 1). As shown in step 3A, for each aisle with pick/drop locations, an average distance to other aisles with pick/drop locations may be calculated. An aisle from the plurality of aisles with minimum average distance to the other aisles may be identified as the default aisle, as shown in step 3B. Referring to 604 in FIG. 6D, a warehouse with three aisles A, B, and C are illustrated. Aisle B is equidistant from aisles A and C. Hence, aisle B may be identified as a default aisle considering the minimum average distance to other aisles A and C. In another embodiment, a default aisle for associating position of the plurality of autonomous mobile vehicles 102 may be identified, based on a frequency of visit of the plurality of autonomous mobile vehicles 102 to the aisles (strategy 2). As shown in step 4A, for each aisle with pick/drop locations, a number of tasks of the plurality of autonomous mobile vehicles 102 is identified. An aisle from the plurality of aisles with maximum number of tasks may be identified as the default aisle, as shown in step 4B. Referring to 602 in FIG. 6D, aisle A is associated with pick/drop locations of two autonomous mobile vehicles, whereas aisles B and C are not associated with any task of autonomous mobile vehicles. Hence, aisle A may be identified as a default aisle.

Reference is made to FIG. 5D illustrating an exemplary flow diagram for identifying an active aisle among the plurality of aisles. As shown in steps 1 and 2, the set of tasks of the plurality of autonomous mobile vehicles 102 may be obtained and iterated to identify whether any task is assigned to any autonomous mobile vehicle of the plurality of autonomous mobile vehicles 102. When it is determined that no task exist, a default aisle is identified as stated above, at step 3A. The default aisle is designated as an active aisle, as shown in step 3B. When there is a task assigned to the plurality of autonomous mobile vehicles 102, pending and in progress picks/drops are identified, at step 4A. The pending picks/drops are associated to nearest aisle, as shown in step 4B. At step 4C, each aisle with at least one pending or in progress pick/drop is designated as an active aisle. Once the active aisles are identified, the density of the autonomous mobile vehicles 102 associated with the active aisles may be determined, as shown in step 4D. Information related to the active aisles and the total density may be cached in a memory or the database.

Reference is made to FIG. 5E illustrating an exemplary flow diagram for assigning tasks to a free autonomous mobile vehicle (or the autonomous mobile vehicle with unassigned tasks). Herein, a robot is considered as the autonomous mobile vehicle 102. As shown in step 1, at least one unassigned task and at least one free robot is identified. At step 2, active aisles and total density of the active aisles are identified. At step 3, unassigned tasks that cannot be carried out by a robot due to weight or space constraints are filtered. At step 4, it is determined whether the robot is already has an assigned task. In case the robot has the assigned task, unassigned tasks that do not share same loading/unloading zone with previously assigned task of the robot is filtered, at step 5. The active aisles set to the assigned task of the robot is filtered at step 6. This ensures the robot always has assigned tasks in the proximity of each other. In case the robot does not have an assigned task, a cost of assigning each task is calculated at step 7. A task with minimum cost is identified at step 8. At step 9, a robot which is nearest to loading zone of the task is identified. The task is assigned to the robot at step 10. At step 11, it is determined whether the robot can carry more tasks/totes. In case the robot can carry more tasks, the cost of assigning task from unassigned tasks is calculated at step 12. In case the robot cannot carry more tasks, the assigned tasks are communicated to the robot.

The other data 220 may store data, including temporary data and temporary files, generated by the one or more modules 210 for performing the various functions of the computing system 106. The other data 220 may be stored in the memory 204. The one or more modules 210 may also include the other modules 230 to perform various miscellaneous functionalities of the computing system 106. It will be appreciated that the one or more modules 210 may be represented as a single module or a combination of different modules.

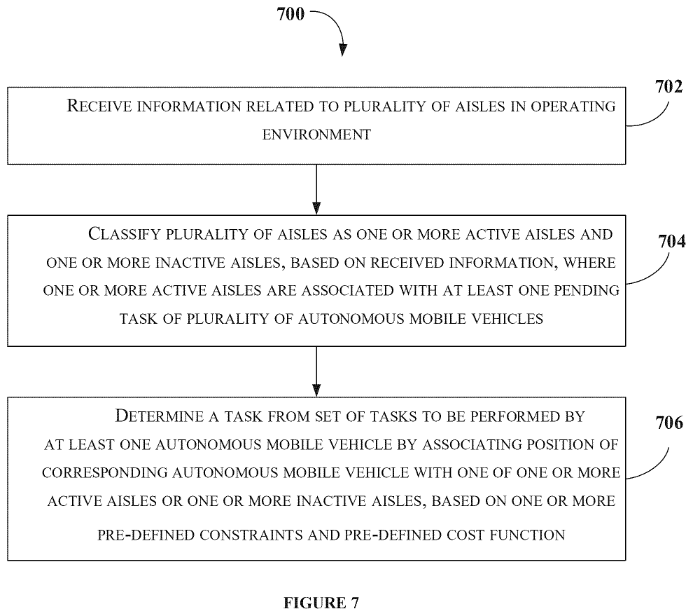

FIG. 7 shows an exemplary flow chart illustrating method steps for operation of the plurality of autonomous mobile vehicles 102 in the operating environment, in accordance with some embodiments of the present disclosure. As illustrated in FIG. 7, the method 700 may comprise one or more steps. The method 700 may be described in the general context of computer executable instructions. Generally, computer executable instructions can include routines, programs, objects, components, data structures, procedures, modules, and functions, which perform particular functions or implement particular abstract data types.

The order in which the method 700 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At step 702, the computing system 106 receives information related to the plurality of aisles in the operating environment. The information related to the plurality of aisles include associations between one of, a pick location or a drop location associated with the set of tasks of each of the plurality of autonomous mobile vehicles 102 and each of the plurality of aisles.

At step 704, the computing system 106 classifies the plurality of aisles as one or more active aisles and one or more inactive aisles, based on the received information. The one or more active aisles are associated with at least one pending task of a plurality of autonomous mobile vehicles 102. The at least one pending task of an autonomous mobile vehicle includes a task that is assigned to the autonomous mobile vehicle which is not initiated. Also, the at least one pending task of an autonomous mobile vehicle includes a task that is assigned to the autonomous mobile vehicle and initiated but is not completed. The one or more inactive aisles comprise aisles other than the one or more active aisles in the plurality of aisles.

At step 706, the computing system 106 determines a task from the set of tasks to be performed by at least one autonomous mobile vehicle from the plurality of autonomous mobile vehicles 102. Herein, the computing system 106 associates a position of the corresponding autonomous mobile vehicle with one of, the one or more active aisles or the one or more inactive aisles, based on the one or more pre-defined constraints and the pre-defined cost function. In an embodiment, the one or more pre-defined constraints may comprise minimizing a number of the one or more active aisles for each task of the set of tasks, activating at least one inactive aisle as an active aisle based on a distance between the at least one inactive aisle and each of the one or more active aisles, maintaining a maximum limit indicating a ratio between a number of autonomous mobile vehicles and a number of the one or more active aisles, and the like. The pre-defined cost function comprises at least one of determining a distance from at least one inactive aisle among the one or more inactive aisles to each of the one or more active aisles.

### COMPUTER SYSTEM

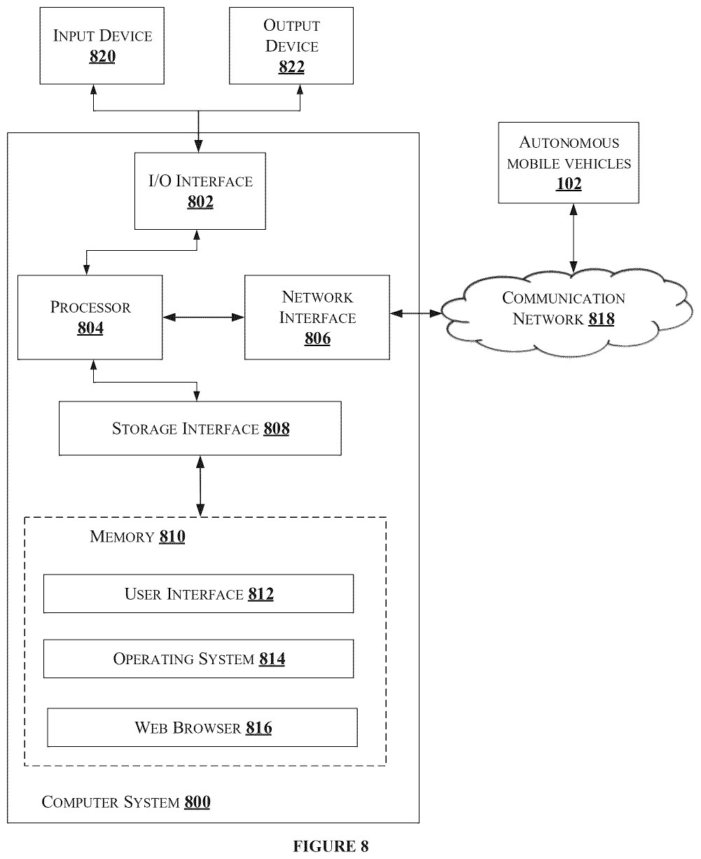

FIG. 8 illustrates a block diagram of an exemplary computer system 800 for implementing embodiments consistent with the present disclosure. In an embodiment, the computer system 800 may be the computing system 106. Thus, the computer system 800 may be used for operation of the plurality of autonomous mobile vehicles 102 in the operating environment. The computer system 800 may communicate with the plurality of autonomous mobile vehicles 102 over a communication network 818. The computer system 800 may comprise a Central Processing Unit 804 (also referred as “CPU” or “processor”). The processor 804 may comprise at least one data processor. The processor 804 may include specialized processing units such as integrated system (bus) controllers, memory management control units, floating point units, graphics processing units, digital signal processing units, etc.

The processor 804 may be disposed in communication with one or more input/output (I/O) devices (not shown) via I/O interface 802. The I/O interface 802 may employ communication protocols/methods such as, without limitation, audio, analog, digital, monoaural, RCA, stereo, IEEE (Institute of Electrical and Electronics Engineers)-1394, serial bus, universal serial bus (USB), infrared, PS/2, BNC, coaxial, component, composite, digital visual interface (DVI), high-definition multimedia interface (HDMI), Radio Frequency (RF) antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 802, the computer system 800 may communicate with one or more I/O devices. For example, the input device 820 may be an antenna, keyboard, mouse, joystick, (infrared) remote control, camera, card reader, fax machine, dongle, biometric reader, microphone, touch screen, touchpad, trackball, stylus, scanner, storage device, transceiver, video device/source, etc. The output device 822 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, etc.

The processor 804 may be disposed in communication with the communication network 818 via a network interface 806. The network interface 806 may communicate with the communication network 818. The network interface 806 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 818 may include, without limitation, a direct interconnection, local area network (LAN), wide area network (WAN), wireless network (e.g., using Wireless Application Protocol), the Internet, etc. The network interface 806 may employ connection protocols include, but not limited to, direct connect, Ethernet (e.g., twisted pair 10/100/1000 Base T), transmission control protocol/internet protocol (TCP/IP), token ring, IEEE 802.11a/b/g/n/x, etc.

The communication network 818 includes, but is not limited to, a direct interconnection, an e-commerce network, a peer to peer (P2P) network, local area network (LAN), wide area network (WAN), wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the first network and the second network may include a variety of network devices, including routers, bridges, servers, computing devices, storage devices, etc.

In some embodiments, the processor 804 may be disposed in communication with a memory 810 (e.g., RAM, ROM, etc. not shown in FIG. 8) via a storage interface 808. The storage interface 808 may connect to memory 810 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 810 may store a collection of program or database components, including, without limitation, user interface 812, an operating system 814, web browser 816 etc. In some embodiments, computer system 800 may store user/application data, such as, the data, variables, records, etc., as described in this disclosure. Such databases may be implemented as fault-tolerant, relational, scalable, secure databases such as Oracle® or Sybase®.

The operating system 814 may facilitate resource management and operation of the computer system 800. Examples of operating systems include, without limitation, APPLE MACINTOSH® OS X, UNIX®, UNIX-like system distributions (E.G., BERKELEY SOFTWARE DISTRIBUTION™ (BSD), FREEBSD™, NETBSD™, OPENBSD™, etc.), LINUX DISTRIBUTIONS™ (E.G., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 800 may implement the web browser 816 stored program component. The web browser 816 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 816 may utilize facilities such as AJAX™, DHTML™, ADOBE® FLASH™, JAVASCRIPT™, JAVA™, Application Programming Interfaces (APIs), etc. In some embodiments, the computer system 800 may implement a mail server (not shown in Figure) stored program component. The mail server may be an Internet mail server such as Microsoft Exchange, or the like. The mail server may utilize facilities such as ASP™, ACTIVEX™, ANSI™ C++/C#, MICROSOFT®, .NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 800 may implement a mail client stored program component. The mail client (not shown in Figure) may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include Random Access Memory (RAM), Read-Only Memory (ROM), volatile memory, non-volatile memory, hard drives, Compact Disc Read-Only Memory (CD ROMs), Digital Video Disc (DVDs), flash drives, disks, and any other known physical storage media.

The present disclosure provides a method and a computing system for operation of autonomous mobile vehicles in an operating environment. The present disclosure utilizes aisles in the operating environment, for managing operation of the autonomous mobile vehicles. The present disclosure enables picking or dropping by an autonomous mobile vehicle in proximity to the active aisles where other autonomous mobile vehicles are already operating. Also, the pick/drop locations of the autonomous mobile vehicles are associated with the inactive aisles only when required and based on a distance of the inactive aisles to all active aisles. In this way, the present disclosure considers various constraints while associating positions of the autonomous mobile vehicles to the aisles for performing the task. This improves productivity in performing the picking/dropping task by reducing the walking time of the pickers.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated operations of FIG. 7 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Yet further, operations may be performed by a single processing unit or by distributed processing units.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the disclosure of the embodiments of the invention is intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A method of operation of autonomous mobile vehicles in an operating environment, the method comprising:
receiving, by a computing system (106), information related to a plurality of aisles in an operating environment;
classifying, by the computing system (106), the plurality of aisles as one or more active aisles and one or more inactive aisles, based on the received information, wherein the one or more active aisles are associated with at least one pending task of a plurality of autonomous mobile vehicles (102); and
determining, by the computing system (106), a task from a set of tasks to be performed by at least one autonomous mobile vehicle from the plurality of autonomous mobile vehicles (102) by associating a position of the corresponding autonomous mobile vehicle with one of, the one or more active aisles or the one or more inactive aisles, based on one or more pre-defined constraints and a pre-defined cost function.

2. The method of claim 1, wherein the information related to the plurality of aisles include associations between one of, a pick location or a drop location associated with the set of tasks of each of the plurality of autonomous mobile vehicles (102) and each of the plurality of aisles.

3. The method of claim 1, wherein the one or more inactive aisles comprise aisles other than the one or more active aisles in the plurality of aisles.

4. The method of claim 1, wherein the task is one of, a picking task or a dropping task, and wherein the picking task is associated with one of, a picking workflow or an induction workflow, and the dropping task is associated with a replenishment workflow in the operating environment.

5. The method of claim 1, wherein the one or more pre-defined constraints comprise at least one of,
minimizing a number of the one or more active aisles for each task of the set of tasks, activating at least one inactive aisle as an active aisle, based on a distance between the at least one inactive aisle and each of the one or more active aisles; and
maintaining a maximum limit indicating a ratio between a number of autonomous mobile vehicles and a number of the one or more active aisles.

6. The method of claim 5, comprising assigning a penalty value when the ratio between the number of autonomous mobile vehicles and the number of the one or more active aisles exceeds the maximum limit.

7. The method of claim 1, wherein associating the position of the at least one autonomous mobile vehicle with the one or more inactive aisles comprises activating the one or more inactive aisles as the one or more active aisles by minimizing the pre-defined cost function.

8. The method of claim 1, wherein the pre-defined cost function comprises at least one of:
determining a distance from at least one inactive aisle among the one or more inactive aisles to each of the one or more active aisles; and
assigning a penalty value while activating the at least one inactive aisle.

9. The method of claim 1, wherein identifying an active aisle from the plurality of aisles comprising:
identifying an aisle of the plurality of aisles with a maximum number of tasks of the plurality of autonomous mobile vehicles (102) as the active aisle for associating the position of the at least one autonomous mobile vehicle, wherein the identification of the aisle as the active aisle is further based on characteristics of the plurality of autonomous mobile vehicles (102).

10. The method of claim 1, wherein identifying an active aisle from the plurality of aisles comprising:
identifying one or more aisles of the plurality of aisles with a maximum number of tasks of the plurality of autonomous mobile vehicles (102);
determining a distance from the one or more aisles to other aisles of the plurality of aisles; and
selecting an aisle from the one or more aisles associated with a minimum distance to the other aisles for associating the position of the at least one autonomous mobile vehicle.

11. A computing system (106) for operation of autonomous mobile vehicles in an operating environment, the system comprises:
a memory (204) for storing processor-executable instructions; and
one or more processors (206) configured to:
receive information related to a plurality of aisles in an operating environment;
classify the plurality of aisles as one or more active aisles and one or more inactive aisles, based on the received information, wherein the one or more active aisles are associated with at least one pending task of a plurality of autonomous mobile vehicles (102); and
determine a task from a set of tasks to be performed by at least one autonomous mobile vehicle from the plurality of autonomous mobile vehicles (102) by associating a position of the corresponding autonomous mobile vehicle with one of, the one or more active aisles and the one or more inactive aisles, based on one or more pre-defined constraints and a pre-defined cost function.

12. The computing system (106) of claim 11, wherein the information related to the plurality of aisles include associations between one of, a pick location or a drop location associated with the set of tasks of each of the plurality of autonomous mobile vehicles (102) and each of the plurality of aisles.

13. The computing system (106) of claim 11, wherein the task is one of, a picking task or a dropping task, and wherein the picking task is associated with one of, a picking workflow or an induction workflow, and the dropping task is associated with a replenishment workflow in the operating environment.

14. The computing system (106) of claim 11, wherein the one or more pre-defined constraints comprise at least one of,
minimizing a number of the one or more active aisles for each task of the set of tasks, activating at least one inactive aisle as an active aisle, based on a distance between the at least one inactive aisle and each of the one or more active aisles; and
maintaining a maximum limit indicating a ratio between a number of autonomous mobile vehicles and a number of the one or more active aisles.

15. The computing system (106) of claim 14, wherein the one or more processors (206) are configured to assign a penalty value when the ratio between the number of autonomous mobile vehicles and the number of the one or more active aisles exceeds the maximum limit.

16. The computing system (106) of claim 11, wherein the one or more processors (206) are configured to associate the position of the at least one autonomous mobile vehicle with the one or more inactive aisles by activating the one or more inactive aisles as the one or more active aisles by minimizing the pre-defined cost function.

17. The computing system (106) of claim 11, wherein the pre-defined cost function comprises at least one of:
determining a distance from at least one inactive aisle among the one or more inactive aisles to each of the one or more active aisles; and assigning a penalty value while activating the at least one inactive aisle.

18. The computing system (106) of claim 11, wherein the one or more processors (206) are configured to identify an active aisle from the plurality of aisles by:
identifying an aisle of the plurality of aisles with a maximum number of tasks of the plurality of autonomous mobile vehicles (102) as the active aisle for associating the position of the at least one autonomous mobile vehicle, wherein the identification of the aisle as the active aisle is further based on characteristics of the plurality of autonomous mobile vehicles (102).

19. The computing system (106) of claim 11, wherein the one or more processors (206) are configured to identify an active aisle from the plurality of aisles by:
identifying one or more aisles of the plurality of aisles with a maximum number of tasks of the plurality of autonomous mobile vehicles (102);
determining a distance from the one or more aisles to other aisles of the plurality of aisles; and
selecting an aisle from the one or more aisles associated with a minimum distance to the other aisles for associating the position of the at least one autonomous mobile vehicle.

20. A non-transitory computer readable medium including instructions stored thereon that when processed by one or more processors (206), wherein the instructions cause a computing system (106) to:
receive information related to a plurality of aisles in an operating environment;
classify the plurality of aisles as one or more active aisles and one or more inactive aisles, based on the received information, wherein the one or more active aisles are associated with at least one pending task of a plurality of autonomous mobile vehicles (102); and
determine a task from a set of tasks to be performed by at least one autonomous mobile vehicle from the plurality of autonomous mobile vehicles (102) by associating a position of the corresponding autonomous mobile vehicle with one of, the one or more active aisles or the one or more inactive aisles, based on one or more pre-defined constraints and a pre-defined cost function.
